(19) United States
(12) Patent Application Publication
(10) Pub. No.: US 2007/0168338 A1
(43) Pub. Date: Jul. 19, 2007

(54) SYSTEMS AND METHODS FOR ACQUIRING ANALYZING MINING DATA AND INFORMATION

(76) Inventors: Charles D. Hartwig, Short Hills, NJ (US); Robert Marciello, Stewartsville, NJ (US); Stuart Kippelman, Flemington, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/624,835

(22) Filed: Jan. 19, 2007

Related U.S. Application Data
(60) Provisional application No. 60/760,138, filed on Jan. 19, 2006.

(51) Int. Cl. G06F 17/30

(52) U.S. Cl. 707/3

(57) ABSTRACT

The present invention provides a method of acquiring, analyzing and mining data and/or information of interest by searching at least one database using at least one primary search term to obtain data and/or information that contains the information of interest to obtain raw data set; applying a data mining tool to the raw data set to obtain mined data; and applying a user interface to the mined data to obtain a visualization of the information of interest.

### PARENT CASE TEXT

This application claims the benefit of U.S. provisional patent application Ser. No. 60/760,138 filed Jan. 19, 2006.

### STATEMENT REGARDING FEDERALLY SPONSORED RESEARCH OR DEVELOPMENT

No government funds were used to make this invention.

### BACKGROUND OF THE INVENTION

Acquiring, processing and mining data remain largely manual procedures with extensive human input. Various aspects have been automated, but the entire process has not yet been integrated to allow a researcher to utilize one integrated system to acquire, analyze, mine and reach conclusions about data and information. Databases with search engines are available such as Google, Dialog and PubMed. Each database has different rules about searching, different “wildcard” usage and different resources such as thesauri. All databases yield raw data set that must be analyzed via direct human interaction or a tool such as OmniViz. U.S. Pat. Nos. 6,070,133, 6,484,168, 6,665,661, 6,718,336, 6,772,170, 6,898,530 and 6,940,509. However, these tools are complex and take a degree of understanding of mathematics and computer programming not available to the typical researcher. Moreover, each tool analyzes the data differently requiring even greater knowledge of mathematics and computer skills. Furthermore, each tool utilizes common concepts, such as thesauri or search criteria, via a proprietary interface. Given the value in being able to compare and contrast search results from various tools, it is critical that the searches be made using identical search terms, identical thesauri, etc. Proprietary interfaces currently preclude different tools from simultaneously utilizing a common interface, data, and synonyms. Even if these tools are used in combination, via manual means, the resulting sorting of data may need to more questions than answers. Generation of analyses of the mined data, production of reports and opinions related to the data still require intensive human effort. The complexity of the process of taking data from a source such as a database, sorting the data to determine what is of interest and analyzing the mined data results in lost time. Moreover, the manual steps required to assure search-consistency between tools leads to insecurity with the thoroughness of the results obtained and inefficiency in commercial ventures.

### SUMMARY OF THE INVENTION

The present invention encompasses a method of acquiring, analyzing and mining data and/or information of interest by searching at least one database using at least one primary search term to obtain data and/or information that contains the information of interest to obtain raw data set; applying a data mining tool to the raw data set to obtain mined data; and applying a user interface to the mined data to obtain a visualization of the information of interest.

The present invention further encompasses use of the method in or to a machine or combination of machines with a computer programmed to perform the method; an article with instructions for performing the method; a method of doing business by conducting the method and providing results therefrom; a system for conducting the method; and reports generated thereby.

### BRIEF DESCRIPTION OF THE DRAWINGS

FIG. 1 depicts the data mining phases.

FIG. 2 depicts the flow of information from a database to a user interface.

FIG. 3 depicts a typical data harvesting result.

FIG. 4 depicts the result of data mining.

FIG. 5 is a screen shot of Wildcard advanced search.

FIG. 6 is a screen shot of Wildcard basic search.

FIG. 7 is a screen shot of Wildcard basic sorting/mining.

FIG. 8 is a screen shot of Wildcard choice of mining analysis tools.

FIG. 9 is a screen shot of Wildcard mining step 1 with topic highlights.

FIG. 10 is a screen shot of Wildcard mining step 1.

FIG. 11 is a screen shot of Wildcard mining step 2 with no topicality.

FIG. 12 is a screen shot of Wildcard mining step 2 with topicality.

FIG. 13 is a screen shot of Wildcard mining step 3 depicting the documents within the chosen data set.

FIG. 14 is a screen shot of Wildcard mining step 3 depicting a subsequent search term of a data set.

### DETAILED DESCRIPTION OF THE INVENTION

The present invention encompasses a method of acquiring, analyzing and mining data and/or information of interest by searching at least one database using at least one primary search term to obtain data and/or information that contains the information of interest to obtain raw data set; applying a data mining tool to the raw data set to obtain mined data; and applying a user interface to the mined data to obtain a visualization of the information of interest.

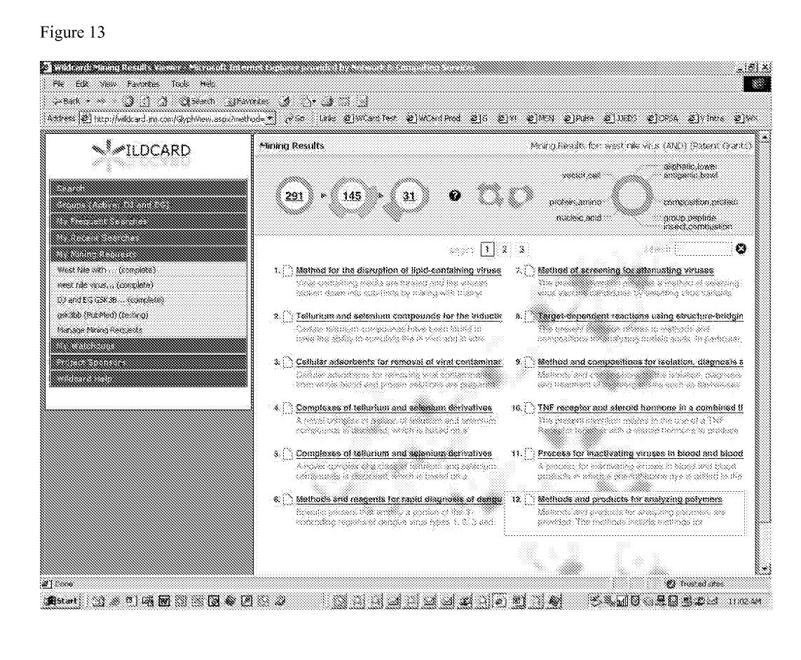

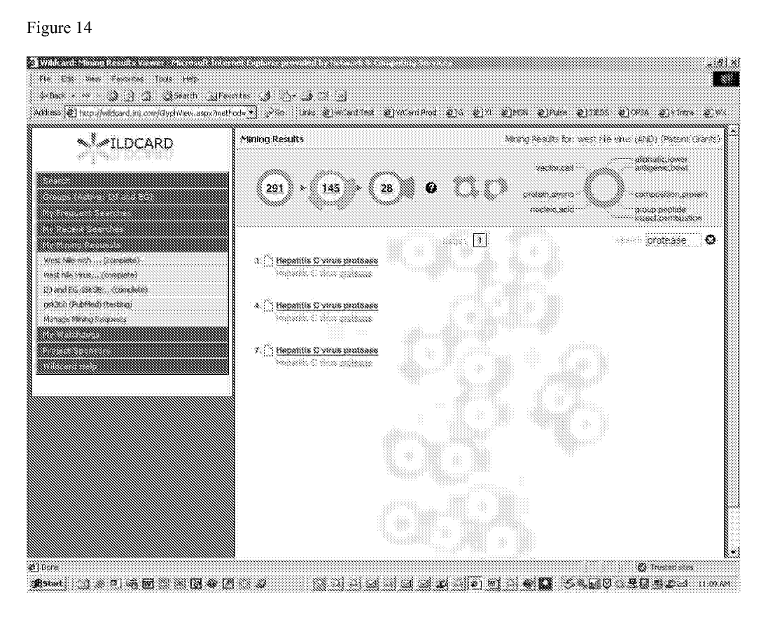

The present invention further encompasses use of the method in or to a machine or combination of machines with a computer programmed to perform the method; an article with instructions for performing the method; a method of doing business by conducting the method and providing results therefrom; a system for conducting the method; and reports generated thereby (FIGS. 13-14).

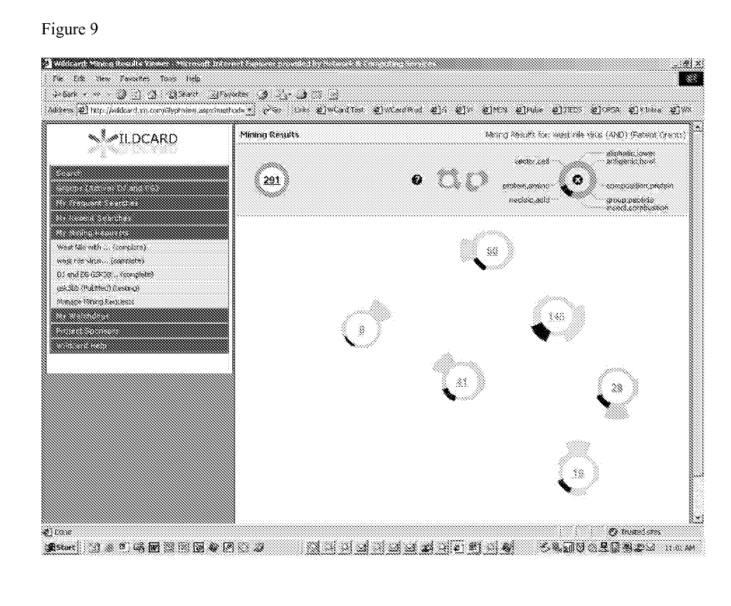

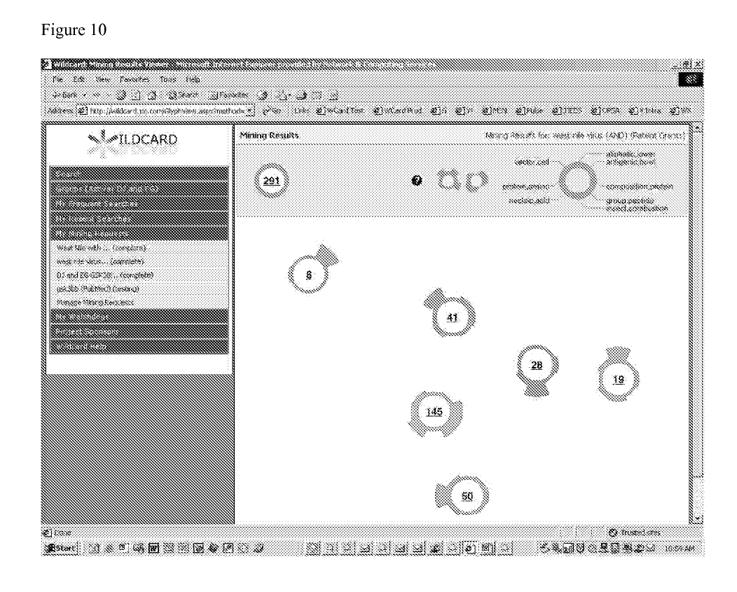

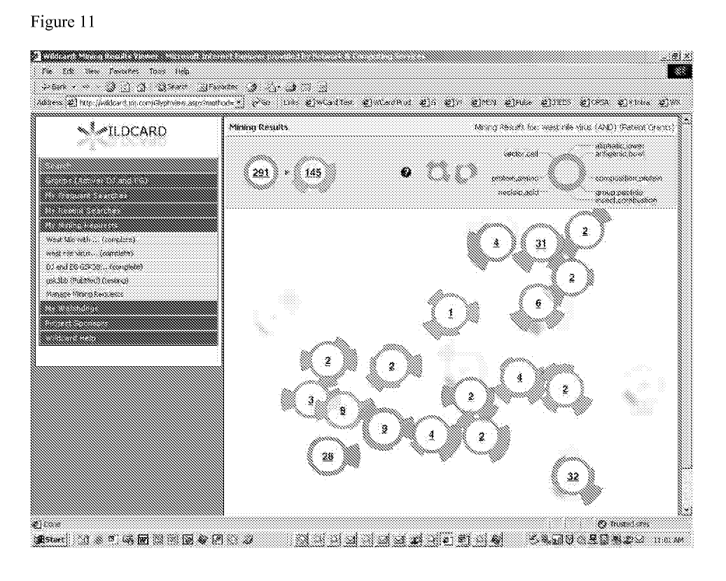

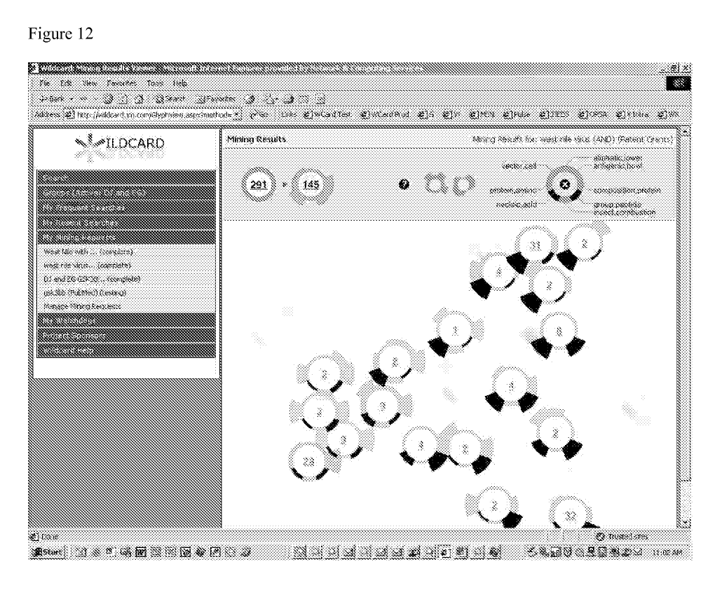

The method may optionally contain the additional step of applying at least one data-synchronized mining tool to the mined data. Preferably, the data-synchronized mining tool clusters the mined data based on topicality (FIGS. 9-12); utilizes at any model known in the art including, without limitation, K-means, Cartesian analysis, a modified molecular model, or a spring model and produces latent derivatives of primary search terms. A latent derivative is, for instance, the result of producing data regarding headaches when the primary search terms were aspirin and pain. The data-synchronized mining tool can be any probabilistic latent semantic analysis known in the art such as Penn Aspect (Hofmann, T. Probabilistic Latent Semantic Analysis. Proceedings of the Fifteenth Conference on Uncertainty in Artificial Intelligence (UAI'99) http://www.cs.brown.edu/˜th/papers/Hofmann-UAI99.pdf, US20020107853; and US20060242118).

The information of interest can be found in any data source known in the art, including, without limitation, intellectual property, literature, microarray pipelines, patient data, output from proprietary experiments, data from instrumentation, market data, census data. The database can be a publicly available database or an internal database. Examples of databases including, without limitation, a United States Patent and Trademark Office database, a World Intellectual Property Organization database, Micropatent™, a European Patent Office database, Dialog™, Medline™, PubMed™, Google™, internal systems, EDGAR, FDA Orange book, Crisp, Lexis/Nexis™ and Westlaw™.

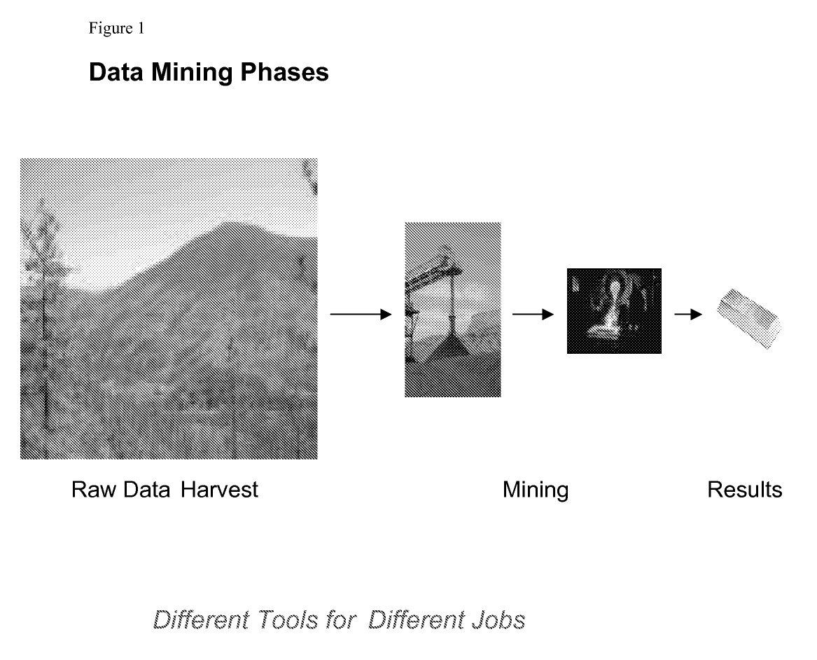

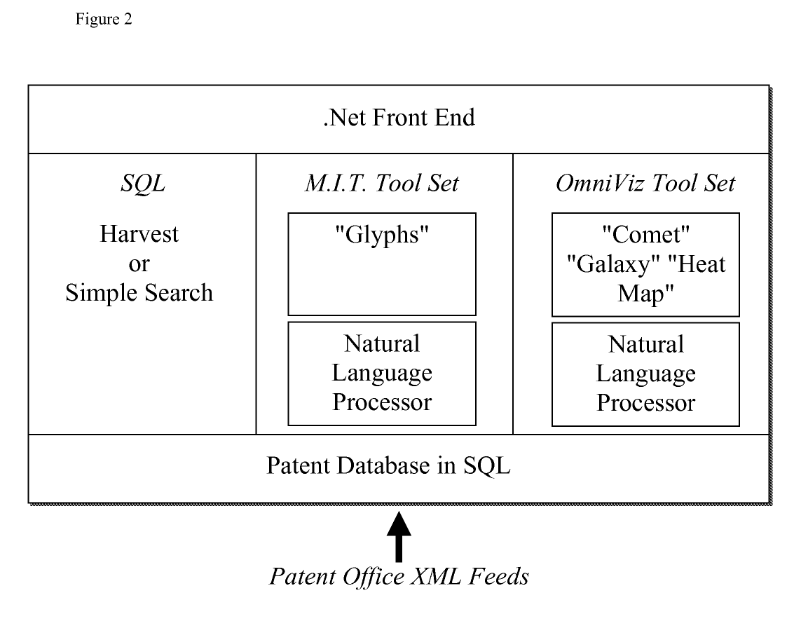

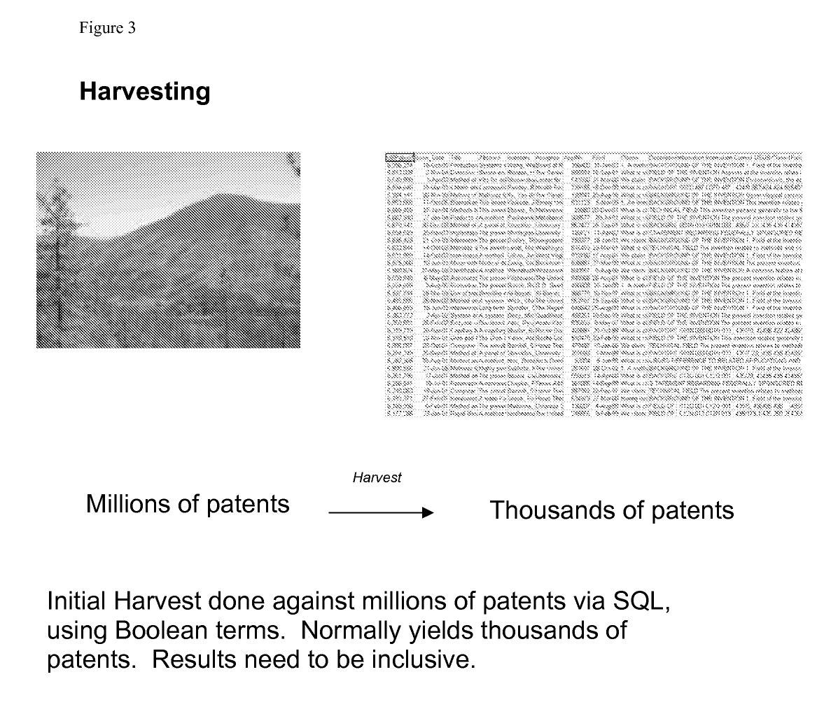

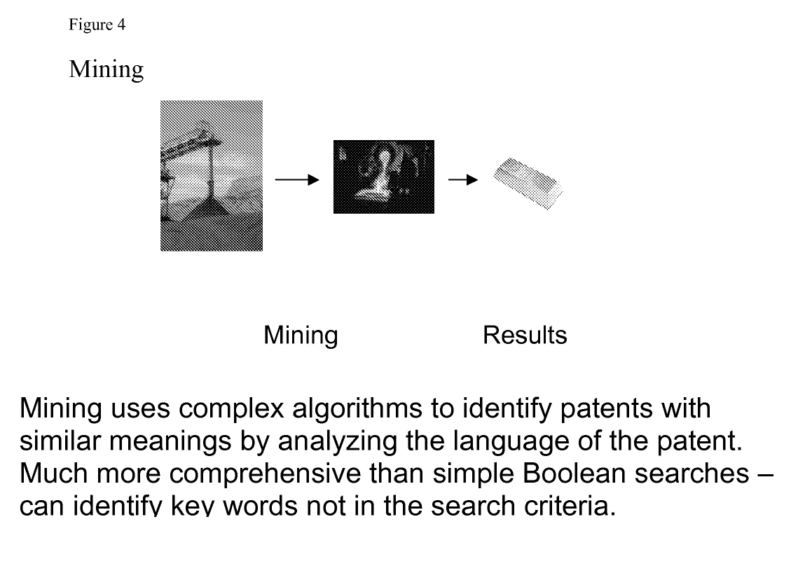

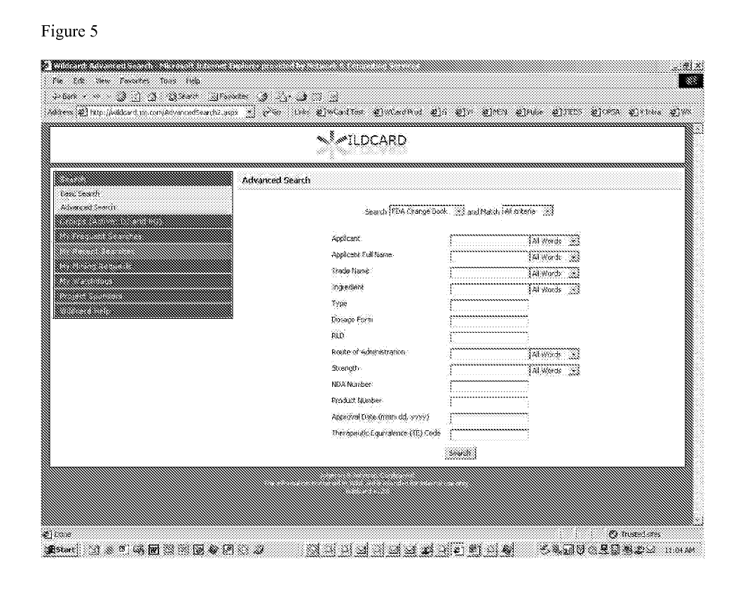

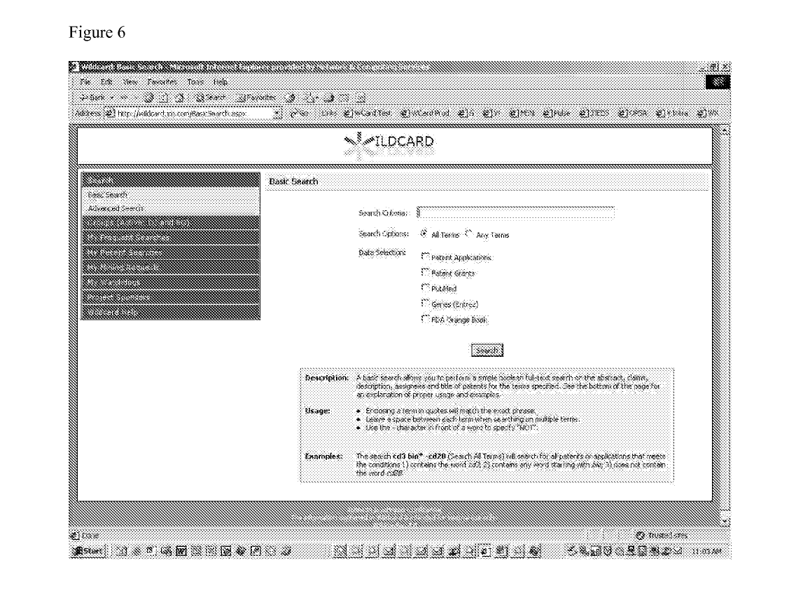

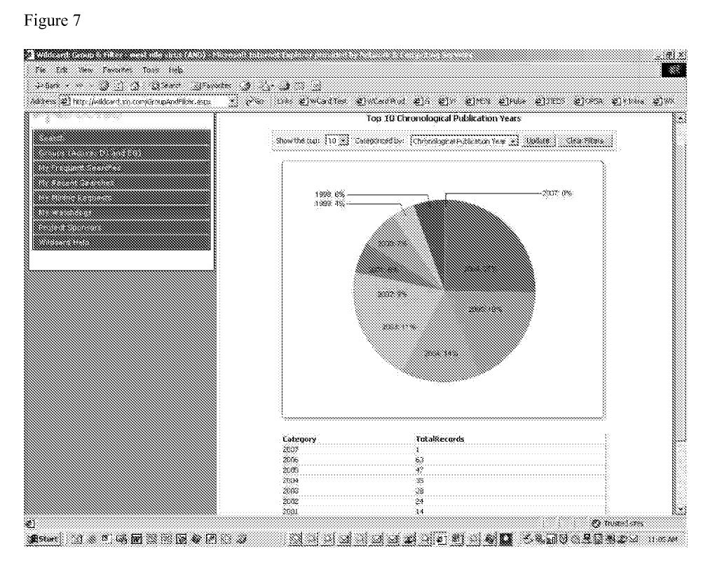

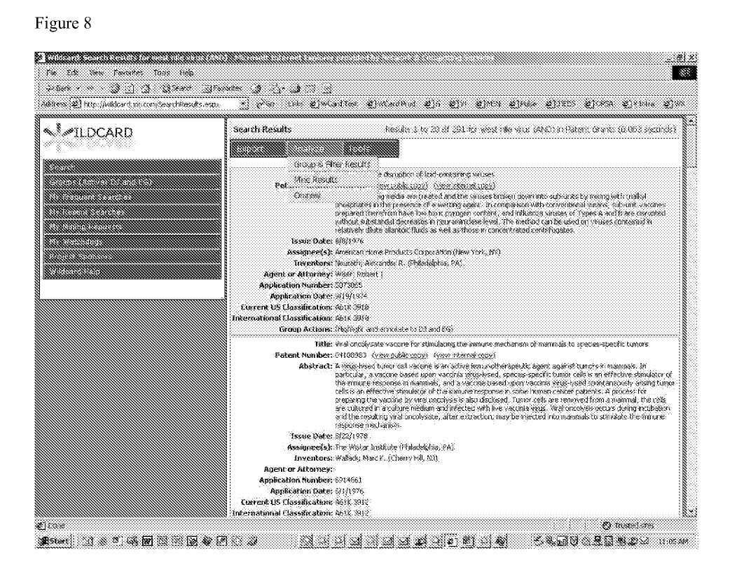

The data mining tool can be any known in the art, including, without limitation, a natural language processor and an SQL harvest, simple search or co-occurrence matrix. The natural language processor can be for instance, OmniViz or an MIT Tool Set. The user interface can be any known in the art, including, without limitation, a computer code comprising subroutines. The process is depicted in FIGS. 1-6 and the visualization is depicted in FIGS. 7 and 8.

The method subroutines provide at least one of consolidating multiple data mining tools onto a single computer screen, letting a user select which tool(s) to use for each search; consolidating multiple data sources into a single computer screen, letting the user select which data source(s) to use for each search; consolidating all thesauri onto the same screen, letting the user select which thesaurus to use for each search; maintaining an electronic history of every search and mining session performed, allowing users to review their own historical searches; allowing review of other user's searches; and maintaining a log of activities that can, itself, be mined by to determine common areas of activity. The common thesaurus can be maintained for each term-category; performing all electronic translations necessary to convert each thesaurus into a form suitable for each tool such as by maintaining a common thesaurus for each term-category allows the ability to evaluate synonyms by category that can be used with any tool. The category can be any known in the art, including, without limitation, company name, disease states and human genes. The translation function allows one common thesaurus (per category) to be used across all tools with no input from the user beyond selecting the tool and thesaurus combination(s).

The present invention provides methods and systems for acquiring, mining and analyzing data via a human—computer interface that leverages human expertise in an efficient, cost-effective method that provides advantages not available in current systems. A computer, no matter how sophisticated, cannot currently read your mind and tell you what you are thinking about. Conversely, very few humans can effectively translate their thoughts into search words/phrases/concepts with the pinpoint accuracy and completeness that a computer requires. The present invention provides the nexus between these two areas of expertise.

The present invention provides the following advantages:

Presents the user with a choice of commercially available and/or internally developed data analysis tools.

Presents the user with a choice of data sources to mine, such as Patents, Output from Proprietary Experiments, Data from OCD Instruments, etc.

Since all data mining tools rely heavily on the use of term-synonyms, the present invention offers a simple interface to maintain term thesauri between users. The present invention modifies the common thesaurus such that it will work with any of the applications/tools in the Wildcard system. Thus each thesaurus is leveraged for use with any mining tool—they are synchronized. This results in improved mining results.

Allows the user to use any or all of these tools, in any combination, with any combination of thesauri, on any of this data. This offers the user the ability to quickly compare/contrast results from different tools, and identify trends and differences. Because the search results come from tools that are using a common, synchronized search/thesaurus combination, it greatly improves the confidence the searcher has in these combined results.

Affords the user the ability to retain prior searches, search for prior searches performed by other users (by topic), etc.

Tracks changes in search results, allowing the user to set up “watch processes” on search terms. For instance, if the user set up a search for the word “lupus,” the user will be informed (via eMail or other electronic means) whenever a document with this word appears in our database. The data can then be reprocessed and re-evaluated.

The ability to perform business intelligence.

### REFERENCES

Brewster, M. et al. (2000) Information Retrieval System Utilizing Wavelet Transform 6,070,133
Crow, V. et al. (2003) System and Method for Use in Text Analysis of Documents and Records 6665661
Crow, V. et al. (2005) Systems and Methods for Improving Concept Landscape Visualizations as a Data Analysis Tool 6940509
Deerwester et al. (1990) Indexing by latent semantic analysis J Am Soc Inf Science 41:391-407
Engel, A. (2006) Classification-expanded indexing and retrieval of classified documents 2006024118
Hofmann, T. Probabilistic Latent Semantic Analysis. Proceedings of the Fifteenth Conference on Uncertainty in Artificial Intelligence (UAI'99) http://www.cs.brown.edu/~th/papers/Hoffman-UAI99.pdf
Hofmann, T. et al. (2002) System and method for personalized search, information filtering, and for generating recommendations utilizing statistical latent class models 20020107853
Pennock, K. et al. (2004) System and Method for Interpreting Document Contents 6772170
Pennock, K. et al. (2002) System For Information Discovery 6484168
Saffer, J. et al. (2004) Data Import System for Data Analysis System 6718336
Saffer, J. et al. (2005) Method and Apparatus for Extracting Attributes from Sequence Strings and Biopolymer Material 6898530
The BOW toolkit for creating term by doc matrices and other text processing and analysis utilities (1998):http://www.cs.cmu.edu/˜mccallum/bow

1. A method of acquiring, analyzing and mining data and/or information of interest comprising the steps of
a. searching at least one database using at least one primary search term to obtain data and/or information that contains the information of interest to obtain raw data set;
b. applying a data mining tool to the raw data set to obtain mined data; and
c. applying a user interface to the mined data to obtain a visualization of the information of interest.

2. The method of claim 1 further comprising optionally applying at least one data-synchronized mining tool to the mined data obtained in step b.

3. The method of claim 1, wherein the information of interest comprises at least one of intellectual property, literature, microarray pipelines, patient data, output from proprietary experiments, data from instrumentation, market data, census data.

4. The method of claim 1, wherein the database is at a publicly available database or an internal database.

5. The method of claim 4, wherein the database is selected from at least one of a United States Patent and Trademark Office database, a World Intellectual Property Organization database, Micropatent™, a European Patent Office database, Dialog™, Medline™, PubMed™, Google™, internal systems, EDGAR, FDA Orange book, Crisp, Lexis/Nexis™ and Westlaw™.

6. The method of claim 1, wherein the data mining tool is selected from a set comprising a natural language processor and an SQL harvest, simple search or co-occurrence matrix.

7. The method of claim 4, wherein the natural language processor comprises OmniViz or an MIT Tool Set.

8. The method of claim 2 wherein the data-synchronized mining tool clusters the mined data based on topicality.

9. The method of claim 8 wherein the data-synchronized mining tool utilizes at least one of K-means, Cartesian analysis, a modified molecular model, or a spring model.

10. The method of claim 8 wherein the data-synchronized mining tool further produces latent derivatives of primary search terms.

11. The method of claim 8 wherein the data-synchronized mining tool is probabilistic latent semantic analysis.

12. The method of claim 1, wherein the user interface is a computer code comprising subroutines.

13. The method of claim 12 wherein the subroutines provide at least one of:
a. consolidating multiple data mining tools onto a single computer screen, letting a user select which tool(s) to use for each search;
b. consolidating multiple data sources into a single computer screen, letting the user select which data source(s) to use for each search;
c. consolidating all thesauri onto the same screen, letting the user select which thesaurus to use for each search;
d. maintaining an electronic history of every search and mining session performed, allowing users to review their own historical searches;
e. allowing review of other user's searches; and
f. maintaining a log of activities that can, itself, be mined by to determine common areas of activity.

14. The method of claim 13 wherein c. further comprises maintaining a common thesaurus for each term-category; performing all electronic translations necessary to convert each thesaurus into a form suitable for each tool.

15. The method of claim 14 wherein maintaining a common thesaurus for each term-category allows the ability to evaluate synonyms by category that can be used with any tool.

16. The method of claim 15, wherein the category is selected from company name, disease states and human genes.

17. The method of claim 16 wherein the translation function allows one common thesaurus (per category) to be used across all tools with no input from the user beyond selecting the tool and thesaurus combination(s).

18. A machine comprising a computer programmed to perform a method for acquiring, analyzing and mining data and/or information of interest wherein the method comprises the steps of
a. searching at least one database using at least one primary search term to obtain data and/or information that contains the information of interest to obtain raw data set;
b. applying a data mining tool to the raw data set to obtain mined data; and
c. applying a user interface to the mined data to obtain a visualization of the information of interest.

19. The method of claim 18 further comprising optionally applying at least one data-synchronized mining tool to the mined data obtained in step b.

20. The method of claim 18, wherein the information of interest comprises at least one of intellectual property, literature, microarray pipelines, patient data, output from proprietary experiments, data from instrumentation, market data, census data.

21. The method of claim 18, wherein the database is at a publicly available database or an internal database.

22. The method of claim 21, wherein the database is selected from at least one of a United States Patent and Trademark Office database, a World Intellectual Property Organization database, Micropatent™, a European Patent Office database, Dialog™, Medline™, PubMed™, Google™, internal systems, EDGAR, FDA Orange book, Crisp, Lexis/Nexis™ and Westlaw™.

23. The method of claim 18, wherein the data mining tool is selected from a set comprising a natural language processor and an SQL harvest, simple search or co-occurrence matrix.

24. The method of claim 23, wherein the natural language processor comprises OmniViz or an MIT Tool Set.

25. The method of claim 19 wherein the data-synchronized mining tool clusters the mined data based on topicality.

26. The method of claim 25 wherein the data-synchronized mining tool utilizes at least one of K-means, Cartesian analysis, a modified molecular model, or a spring model.

27. The method of claim 25 wherein the data-synchronized mining tool further produces latent derivatives of primary search terms.

28. The method of claim 25 wherein the data-synchronized mining tool is probabilistic latent semantic analysis.

29. The method of claim 18, wherein the user interface is a computer code comprising subroutines.

30. The method of claim 29 wherein the subroutines provide at least one of:
a. consolidating multiple data mining tools onto a single computer screen, letting a user select which tool(s) to use for each search;
b. consolidating multiple data sources into a single computer screen, letting the user select which data source(s) to use for each search;
c. consolidating all thesauri onto the same screen, letting the user select which thesaurus to use for each search;
d. maintaining an electronic history of every search and mining session performed, allowing users to review their own historical searches;
e. allowing review of other user's searches; and
f. maintaining a log of activities that can, itself, be mined by to determine common areas of activity.

31. The method of claim 30 wherein c. further comprises maintaining a common thesaurus for each term-category; performing all electronic translations necessary to convert each thesaurus into a form suitable for each tool.

32. The method of claim 31 wherein maintaining a common thesaurus for each term-category allows the ability to evaluate synonyms by category that can be used with any tool.

33. The method of claim 32, wherein the category is selected from company name, disease states and human genes.

34. The method of claim 33 wherein the translation function allows one common thesaurus (per category) to be used across all tools with no input from the user beyond selecting the tool and thesaurus combination(s).

35. A combination of machines comprising at least one computer programmed to perform a method for acquiring, analyzing and mining data and/or information of interest wherein the method comprises the steps of
a. searching at least one database using at least one primary search term to obtain data and/or information that contains the information of interest to obtain raw data set;
b. applying a data mining tool to the raw data set to obtain mined data; and
c. applying a user interface to the mined data to obtain a visualization of the information of interest.

36. The method of claim 35 further comprising optionally applying at least one data-synchronized mining tool to the mined data obtained in step b.

37. The method of claim 35, wherein the information of interest comprises at least one of intellectual property, literature, microarray pipelines, patient data, output from proprietary experiments, data from instrumentation, market data, census data.

38. The method of claim 35, wherein the database is at a publicly available database or an internal database.

39. The method of claim 38, wherein the database is selected from at least one of a United States Patent and Trademark Office database, a World Intellectual Property Organization database, Micropatent™, a European Patent Office database, Dialog™, Medline™, PubMed™, Google™, internal systems, EDGAR, FDA Orange book, Crisp, Lexis/Nexis™ and Westlaw™.

40. The method of claim 35, wherein the data mining tool is selected from a set comprising a natural language processor and an SQL harvest, simple search or co-occurrence matrix.

41. The method of claim 40, wherein the natural language processor comprises OmniViz or an MIT Tool Set.

42. The method of claim 36 wherein the data-synchronized mining tool clusters the mined data based on topicality.

43. The method of claim 36 wherein the data-synchronized mining tool utilizes at least one of K-means, Cartesian analysis, a modified molecular model, or a spring model.

44. The method of claim 43 wherein the data-synchronized mining tool further produces latent derivatives of primary search terms.

45. The method of claim 43 wherein the data-synchronized mining tool is probabilistic latent semantic analysis.

46. The method of claim 36, wherein the user interface is a computer code comprising subroutines.

47. The method of claim 46 wherein the subroutines provide at least one of:
a. consolidating multiple data mining tools onto a single computer screen, letting a user select which tool(s) to use for each search;
b. consolidating multiple data sources into a single computer screen, letting the user select which data source(s) to use for each search;
c. consolidating all thesauri onto the same screen, letting the user select which thesaurus to use for each search;
d. maintaining an electronic history of every search and mining session performed, allowing users to review their own historical searches;
e. allowing review of other user's searches; and
f. maintaining a log of activities that can, itself, be mined by to determine common areas of activity.

47. The method of claim 46 wherein c. further comprises maintaining a common thesaurus for each term-category; performing all electronic translations necessary to convert each thesaurus into a form suitable for each tool.

48. The method of claim 47 wherein maintaining a common thesaurus for each term-category allows the ability to evaluate synonyms by category that can be used with any tool.

49. The method of claim 48, wherein the category is selected from company name, disease states and human genes.

50. The method of claim 49 wherein the translation function allows one common thesaurus (per category) to be used across all tools with no input from the user beyond selecting the tool and thesaurus combination(s).

51. An article comprising instructions for conducting a method of acquiring, analyzing and mining data and/or information of interest wherein the method comprises the steps of
a. searching at least one database using at least one primary search term to obtain data and/or information that contains the information of interest to obtain raw data set;
b. applying a data mining tool to the raw data set to obtain mined data; and
c. applying a user interface to the mined data to obtain a visualization of the information of interest.

52. The method of claim 51 further comprising optionally applying at least one data-synchronized mining tool to the mined data obtained in step b.

53. The method of claim 51, wherein the information of interest comprises at least one of intellectual property, literature, microarray pipelines, patient data, output from proprietary experiments, data from instrumentation, market data, census data.

54. The method of claim 51, wherein the database is at a publicly available database or an internal database.

55. The method of claim 54, wherein the database is selected from at least one of a United States Patent and Trademark Office database, a World Intellectual Property Organization database, Micropatent™, a European Patent Office database, Dialog™, Medline™, PubMed™, Google™, internal systems, EDGAR, FDA Orange book, Crisp, Lexis/Nexis™ and Westlaw™.

56. The method of claim 51, wherein the data mining tool is selected from a set comprising a natural language processor and an SQL harvest, simple search or co-occurrence matrix.

57. The method of claim 54, wherein the natural language processor comprises OmniViz or an MIT Tool Set.

58. The method of claim 52 wherein the data-synchronized mining tool clusters the mined data based on topicality.

59. The method of claim 58 wherein the data-synchronized mining tool utilizes at least one of K-means, Cartesian analysis, a modified molecular model, or a spring model.

60. The method of claim 58 wherein the data-synchronized mining tool further produces latent derivatives of primary search terms.

61. The method of claim 58 wherein the data-synchronized mining tool is probabilistic latent semantic analysis.

62. The method of claim 51, wherein the user interface is a computer code comprising subroutines.

63. The method of claim 62 wherein the subroutines provide at least one of:
a. consolidating multiple data mining tools onto a single computer screen, letting a user select which tool(s) to use for each search;
b. consolidating multiple data sources into a single computer screen, letting the user select which data source(s) to use for each search;
c. consolidating all thesauri onto the same screen, letting the user select which thesaurus to use for each search;
d. maintaining an electronic history of every search and mining session performed, allowing users to review their own historical searches;
e. allowing review of other user's searches; and
f. maintaining a log of activities that can, itself, be mined by to determine common areas of activity.

64. The method of claim 63 wherein c. further comprises maintaining a common thesaurus for each term-category; performing all electronic translations necessary to convert each thesaurus into a form suitable for each tool.

65. The method of claim 64 wherein maintaining a common thesaurus for each term-category allows the ability to evaluate synonyms by category that can be used with any tool.

66. The method of claim 65, wherein the category is selected from company name, disease states and human genes.

67. The method of claim 66 wherein the translation function allows one common thesaurus (per category) to be used across all tools with no input from the user beyond selecting the tool and thesaurus combination(s).

68. A method of doing business comprising conducting a method of acquiring, analyzing and mining data and/or information of interest wherein the method of acquiring, analyzing and mining data and/or information of interest comprises the steps of
a. searching at least one database using at least one primary search term to obtain data and/or information that contains the information of interest to obtain raw data set;
b. applying a data mining tool to the raw data set to obtain mined data; and
c. applying a user interface to the mined data to obtain a visualization of the information of interest.

69. The method of claim 68 further comprising optionally applying at least one data-synchronized mining tool to the mined data obtained in step b.

70. The method of claim 68, wherein the information of interest comprises at least one of intellectual property, literature, microarray pipelines, patient data, output from proprietary experiments, data from instrumentation, market data, census data.

71. The method of claim 68, wherein the database is at a publicly available database or an internal database.

72. The method of claim 71, wherein the database is selected from at least one of a United States Patent and Trademark Office database, a World Intellectual Property Organization database, Micropatent™, a European Patent Office database, Dialog™, Medline™, PubMed™, Google™, internal systems, EDGAR, FDA Orange book, Crisp, Lexis/Nexis™ and Westlaw™.

73. The method of claim 68, wherein the data mining tool is selected from a set comprising a natural language processor and an SQL harvest, simple search or co-occurrence matrix.

74. The method of claim 73, wherein the natural language processor comprises OmniViz or an MIT Tool Set.

75. The method of claim 69 wherein the data-synchronized mining tool clusters the mined data based on topicality.

76. The method of claim 75 wherein the data-synchronized mining tool utilizes at least one of K-means, Cartesian analysis, a modified molecular model, or a spring model.

77. The method of claim 75 wherein the data-synchronized mining tool further produces latent derivatives of primary search terms.

78. The method of claim 75 wherein the data-synchronized mining tool is probabilistic latent semantic analysis.

79. The method of claim 68, wherein the user interface is a computer code comprising subroutines.

80. The method of claim 79 wherein the subroutines provide at least one of:
a. consolidating multiple data mining tools onto a single computer screen, letting a user select which tool(s) to use for each search;
b. consolidating multiple data sources into a single computer screen, letting the user select which data source(s) to use for each search;
c. consolidating all thesauri onto the same screen, letting the user select which thesaurus to use for each search;
d. maintaining an electronic history of every search and mining session performed, allowing users to review their own historical searches;
e. allowing review of other user's searches; and
f. maintaining a log of activities that can, itself, be mined by to determine common areas of activity.

81. The method of claim 80 wherein c. further comprises maintaining a common thesaurus for each term-category; performing all electronic translations necessary to convert each thesaurus into a form suitable for each tool.

82. The method of claim 81 wherein maintaining a common thesaurus for each term-category allows the ability to evaluate synonyms by category that can be used with any tool.

83. The method of claim 82, wherein the category is selected from company name, disease states and human genes.

84. The method of claim 83 wherein the translation function allows one common thesaurus (per category) to be used across all tools with no input from the user beyond selecting the tool and thesaurus combination(s).

85. A system for conducting a method of acquiring, analyzing and mining data and/or information of interest wherein the method comprises the steps of
a. searching at least one database using at least one primary search term to obtain data and/or information that contains the information of interest to obtain raw data set;
b. applying a data mining tool to the raw data set to obtain mined data; and
c. applying a user interface to the mined data to obtain a visualization of the information of interest.

86. The method of claim 85 further comprising optionally applying at least one data-synchronized mining tool to the mined data obtained in step b.

87. The method of claim 85, wherein the information of interest comprises at least one of intellectual property, literature, microarray pipelines, patient data, output from proprietary experiments, data from instrumentation, market data, census data.

88. The method of claim 85, wherein the database is at a publicly available database or an internal database.

89. The method of claim 88, wherein the database is selected from at least one of a United States Patent and Trademark Office database, a World Intellectual Property Organization database, Micropatent™, a European Patent Office database, Dialog™, Medline™, PubMed™, Google™, internal systems, EDGAR, FDA Orange book, Crisp, Lexis/Nexis™ and Westlaw™.

90. The method of claim 85, wherein the data mining tool is selected from a set comprising a natural language processor and an SQL harvest, simple search or co-occurrence matrix.

91. The method of claim 90, wherein the natural language processor comprises OmniViz or an MIT Tool Set.

92. The method of claim 86 wherein the data-synchronized mining tool clusters the mined data based on topicality.

93. The method of claim 92 wherein the data-synchronized mining tool utilizes at least one of K-means, Cartesian analysis, a modified molecular model, or a spring model.

94. The method of claim 92 wherein the data-synchronized mining tool further produces latent derivatives of primary search terms.

95. The method of claim 92 wherein the data-synchronized mining tool is probabilistic latent semantic analysis.

96. The method of claim 85, wherein the user interface is a computer code comprising subroutines.

97. The method of claim 96 wherein the subroutines provide at least one of:
a. consolidating multiple data mining tools onto a single computer screen, letting a user select which tool(s) to use for each search;
b. consolidating multiple data sources into a single computer screen, letting the user select which data source(s) to use for each search;
c. consolidating all thesauri onto the same screen, letting the user select which thesaurus to use for each search;
d. maintaining an electronic history of every search and mining session performed, allowing users to review their own historical searches;
e. allowing review of other user's searches; and
f. maintaining a log of activities that can, itself, be mined by to determine common areas of activity.

98. The method of claim 97 wherein c. further comprises maintaining a common thesaurus for each term-category; performing all electronic translations necessary to convert each thesaurus into a form suitable for each tool.

99. The method of claim 98 wherein maintaining a common thesaurus for each term-category allows the ability to evaluate synonyms by category that can be used with any tool.

100. The method of claim 99, wherein the category is selected from company name, disease states and human genes.

101. The method of claim 99 wherein the translation function allows one common thesaurus (per category) to be used across all tools with no input from the user beyond selecting the tool and thesaurus combination(s).

102. A report generated by any one of claims 1-101.
